(19) United States
(12) Patent Application Publication
(10) Pub. No.: US 2009/0145894 A1
(43) Pub. Date: Jun. 11, 2009

(54) Passive inductor for improved control in localized heating of thin bodies

(75) Inventor: Robert C. Goldstein, Grand Blanc, MI (US)

Correspondence Address: WARN, HOFFMANN, MILLER & LALONE, .P.C, PO BOX 70098, ROCHESTER HILLS, MI, 48307, US

(73) Assignee: Fluxtrol Inc., Auburn Hills, MI (US)

(21) Appl. No.: 12/313,441

(22) Filed: Nov. 20, 2008

Related U.S. Application Data
(60) Provisional application No. 61/003,815, filed on Nov. 20, 2007.

(51) Int. Cl. H05B 6/04

(52) U.S. Cl. 219/670

(57) ABSTRACT

The present invention is a magnetic flux controlling device in the form of a passive inductor which improves heat pattern control for induction heating of objects such as thin, flat bodies. The device comprises a magnetic core and at least one electrical conductor that together do not form a closed electrical loop. The device is located on the opposite side of the object to be heated from the induction coil and may be adjusted along the axis of the induction coil to manipulate the heat pattern in different zones of the part.

### CROSS-REFERENCE TO RELATED APPLICATIONS

This application claims the benefit of U.S. Provisional Application No. 61/003,815, filed Nov. 20, 2007.

### FIELD OF THE INVENTION

The present invention relates to local induction heating of thin bodies, and more particularly to the increased power distribution control using a passive inductor located on the opposite side of a thin, flat body in relation to the inductor.

### BACKGROUND OF THE INVENTION

Induction heating is becoming a more popular technique for applications where very specific heating of small areas on thin, flat bodies is required. These applications include, but are not limited to, package sealing, joining of electrical and electronic components. In the past, these applications primarily utilized contact heating methods, such as a hot bar. However, due to demands for increased product quality, production rate, tool life and ability to use lower cost materials, induction heating has become a preferred method for new systems.

Induction heating involves an induction coil, which can have many configurations, and also carries an alternating frequency current. This current generates an alternating magnetic field, which in turn, induces eddy currents in conductive bodies that are exposed to the alternating magnetic field. It also causes hysteretic heating of magnetic bodies exposed to the field. The distribution of eddy currents and hysteretic heating depends upon the shape of the induction coil, the level of alternating magnetic field, the shape of the conductive body, the orientation of the conductive body relative to the magnetic field and the electrical and magnetic properties of the body.

One type of application, where induction heating is frequently used, is a thin, flat body. Prior art methods of induction heating for a thin, flat body are shown in FIGS. 1A-1F, FIG. 2, and FIG. 3. A typical induction heating system includes an induction coil or induction heating coil, generally shown at 10, which includes individual coil windings 12 wound around an axis 44. The coil windings 12 may or may not be surrounded by a concentrator 16. A concentrator 16 is a device made of soft magnetic material and is used for concentrating a magnetic field, resulting in the heating of a part in a desired area. The induction coil 10 is placed in proximity to a thin, flat object or body 18, which is substantially transparent to a magnetic field. The body 18 is shown in FIGS. 1A-1F, FIG. 2, and FIG. 3 as a thin sheet and the induction coil 10 is used to provide localized heating of the sheet 18. For local induction heating of thin, flat bodies such as the flat sheet 18, higher efficiencies and better control are possible if the magnetic field generated by the induction coil 10 is transversal to the body 18.

Common styles of coils used for heating of thin, flat bodies 18 are shown in FIGS. 1A-1F. FIG. 1A shows an induction coil 10 which can be of a cylindrical or linear nature and can be of a single turn or multi-turn type, and may or may not have a magnetic core. The induction coil 10 of FIG. 1A is referred to as a “hairpin” if the windings 12 extend into and out of the page. FIG. 1B shows an induction coil 10 similar to FIG. 1A, which can be a hairpin, single turn or multi-turn inductor, but also incorporates a magnetic back-pad 24. FIG. 1C shows an induction coil which is a multi-turn flat hairpin coil (or “pancake” coil if the coil windings 12 are cylindrical). FIG. 1D shows a split-n-return induction coil 10, and FIG. 1E shows a vertical loop induction coil 10, which can be used depending upon the desired heating area and space available. FIG. 1F shows a two-sided hairpin or round induction coil 10; the induction coil 10 of FIG. 1F is also referred to as a transverse flux inductor. The frequency used for these applications can range from 10 kHz to 2 MHz, with a preferred range of 50 kHz-1 MHz.

To demonstrate the principle operation of an induction coil 10, an Example is shown in FIG. 2 of a small, two-turn cylindrical coil 10 with a magnetic core for heating of a circular area on a thin, flat body, such as foil 18. FIG. 2 shows the magnetic field lines 20 generated by the induction coil 10. The magnetic field attenuates with distance from the magnetic core and windings 12. Those skilled in the art will recognize that the maximum in power density will be at a radius significantly larger than the diameter of the windings 12.

FIG. 3 shows the magnetic field lines 22 for the same induction coil 10 located next to the same foil 18 when a magnetic back-pad 24 is used. The magnetic back-pad 24 attracts the magnetic field passing through the foil 18 and makes the magnetic field lines 22 more transverse to the foil 18. It is clear from these lines 22 that the power density will be significantly more concentrated, leading to a smaller spot size.

In many of these applications, there are significant savings that are realized by minimizing the zone of thermal influence from the coil 10. These savings may result from better utilization of material (higher component density) or reduced scrap (extra area for bonding or material breakage due to thermal strain in semiconductors). In other cases, there are components adjacent to the desired heating area of the body 18 that if exposed to elevated temperatures or alternating magnetic fields will cause damage to the final product.

Properly designed two-sided inductors, such as the example shown in FIG. 1F, can provide better control and higher efficiencies than inductors that heat from only one-side due to mutual inductance of the windings 12 on opposite sides of the part to be heated. The drawback of two-sided inductors is that they require electrical and/or water connections between the two inductor halves. This can be impractical in many in-line processing systems.

In cases where two-sided inductors are not practical, one of the varieties of one-sided inductors shown in FIGS. 1A-1E may be used. Heat pattern control in one-sided inductors is accomplished through variation of the geometry of the windings 12, magnetic flux controller material or geometry variation, and in some cases with the use of the magnetic back pad 24 shown in FIG. 1B, placed selectively on the opposite side of the sheet 18. The magnetic flux controller on the opposite side of the sheet 18 helps to increase the component of magnetic field transverse to the surface of the sheet 18, and increases heating in the area with a concentrator relative to adjacent zones. This method is considered to be the best available technology for local heating and joining where two-sided inductors are not possible. One of the drawbacks to this method is that the control achieved with this method does not match that for the two-sided inductors.

In view of the foregoing, there exists a need to provide a device or devices for magnetic field control on the backside of the work piece (or magnetic body) that would provide improved heat pattern control for one-sided heating inductors while at the same time approaching the performance of two-sided inductors, without requiring an electrical connection.

### SUMMARY OF THE INVENTION

The above and other objects are achieved by the present invention, which is a passive inductor located on the opposite side of a part in relation to the induction coil. The part may be a thin, flat body, with the induction coil on one side, and the passive inductor on the other. One embodiment of the present invention is a passive inductor which provides magnetic flux control from the opposite side of a part as the induction coil. The passive inductor is a magnetic flux controlling device, which contains a magnetic core and at least one conductor that do not form a closed electrical loop.

Another embodiment of the present invention is a magnetic flux controlling device having a passive inductor for generating induction heating of an object. The passive inductor includes at least one electrical conductor operable for generating a desired heating area on the object. The electrical conductor may optionally include a magnetic flux concentrator which also generates a desired heating area on the object. The electrical conductor does not form a closed electrical loop.

Operation of the present invention, areas of applicability and provided effects will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

FIG. 1A is a schematic sectional view of a first type of induction coil used for heating a thin flat, body;

FIG. 1B is a schematic sectional view of a second type of induction coil used for heating a thin flat, body;

FIG. 1C is a schematic sectional view of a third type of induction coil used for heating a thin flat, body;

FIG. 1D is a schematic sectional view of a fourth type of induction coil used for heating a thin flat, body;

FIG. 1E is a schematic sectional view of a fifth type of induction coil used for heating a thin flat, body;

FIG. 1F is a schematic sectional view of sixth type of induction coil used for heating a thin flat, body;

FIG. 2 is a sectional side view of a type of induction coil and magnetic field generated by the induction coil used for local heating of a small spot on a thin, flat body;

FIG. 3 is a sectional side view of a type of induction coil used with a magnetic back-pad to provide local heating of a small spot on a thin, flat body;

FIG. 4 is a sectional side view if an induction coil used with a passive inductor for providing local heating of a small spot on a strip, according to the present invention;

FIG. 5 is a first graphical comparison of relative power density distribution for prior art induction coils and a passive induction system, according to the present invention; and

FIG. 6 is a second graphical comparison of relative power density distribution for prior art induction coils and a passive induction system, according to the present invention.

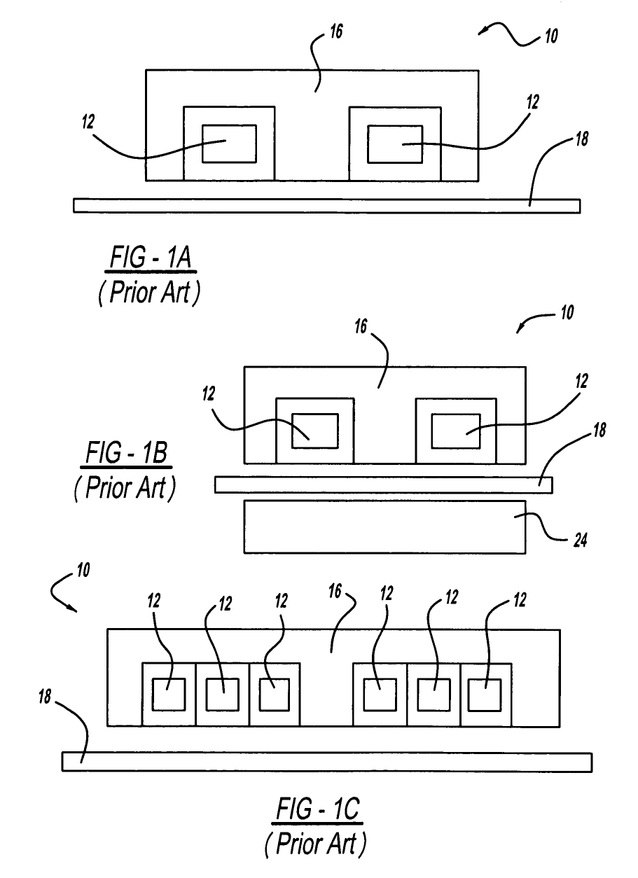

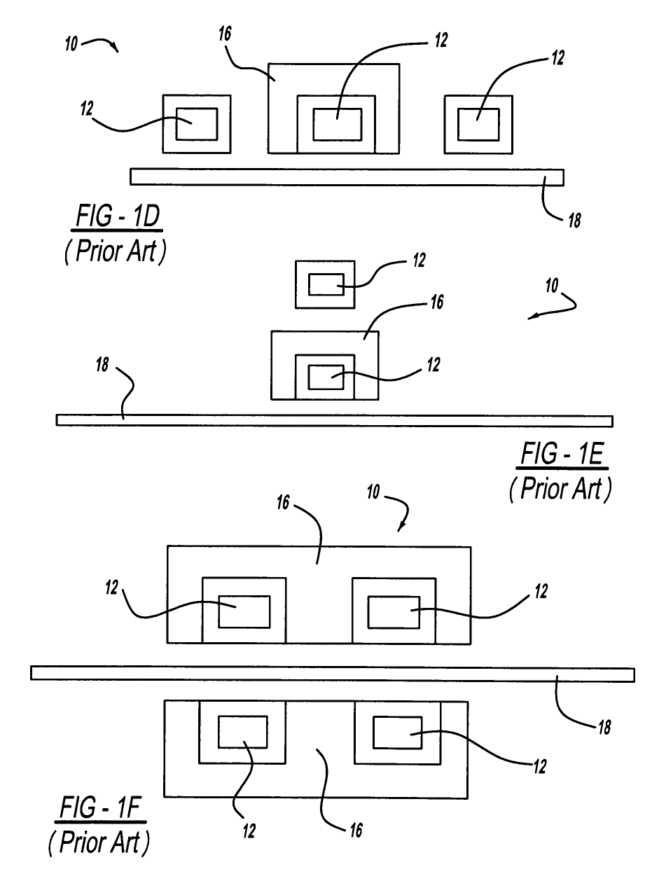

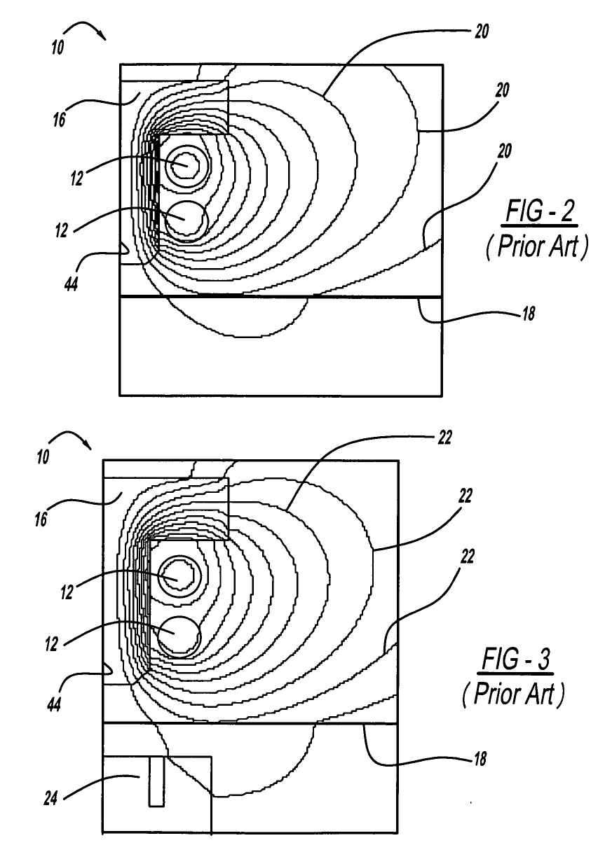

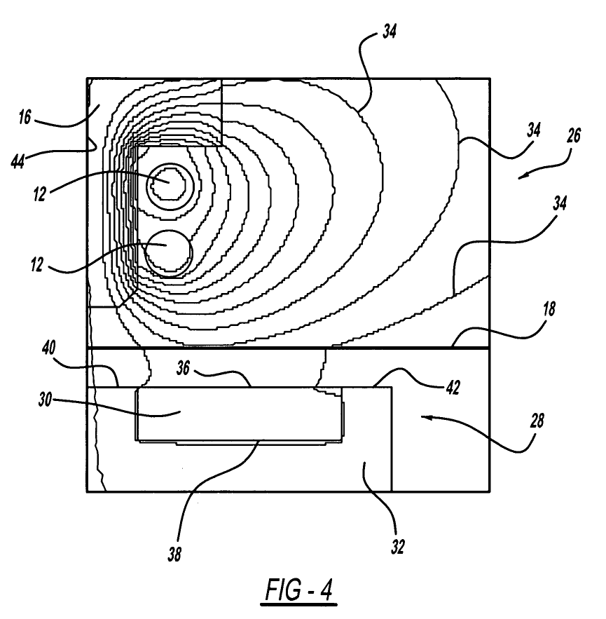

### DETAILED DESCRIPTION OF THE INVENTION

The following description of the preferred embodiments is merely exemplary in nature and is in no way intended to limit the invention, its application, or uses.

A passive induction system according to the present invention is shown in FIG. 4, generally at 26. The passive induction system 26 of the present invention also includes an induction coil 10 which includes induction coil windings 12, which work in a similar fashion to the prior art embodiments described above. However, also included is a second inductor, or passive inductor, generally shown at 28, which, in relation to the inductor 10, is positioned on the opposite side of the sheet 18. The passive inductor 28 may be used with or without a magnetic flux concentrator, and does not form a closed electrical loop. In a preferred embodiment, the passive inductor 28 has a conductor 30 which is optionally surrounded by a magnetic flux concentrator in the form of a core 32. The core 32 may or may not be used, depending upon the amount of heat desired. The core 32 is made up of any soft magnetic material such as ferrites, soft magnetic composite materials (such as Fluxtrol® brand material, available from Fluxtrol Inc., Auburn Hills, Mich.), insulated lamination, or combinations of these. In some cases, soft magnetic alloys may be used, depending upon the frequency used for heating. The conductor 30 has a front side 36 and a back side 38, and is made of any electrically conductive material, and is preferably a non-magnetic conductor. By way of explanation and not limitation, the conductor 30 may be made up of aluminum, copper, silver, or brass, or combinations of these. The core 32 surrounding the conductor 30 has a first flux surface 40 and a second flux surface 42. The passive inductor 28 of the present invention operates by redirecting the magnetic field from the induction coil windings 12.

FIG. 4 shows the magnetic field lines 34 generated by a passive induction system 26 according to the present invention. The magnetic field is drawn to the central core 32 of the passive inductor 28, in a similar manner as the magnetic back-pad 24 as described above. However, as the passive inductor 28 is moved towards the inductor 10, the magnetic field cannot pass through the conductor 30 itself, the magnetic field is redirected either through the central magnetic core 32, or away from the front side 36. The magnetic field that flows through magnetic core 32 via the flux surfaces 40,42, then flows through the core 32 on the back side 38 of the conductor 30 and returns on the outside of the conductor 30 via the flux surfaces 40,42. This increases the transversal component of the magnetic field in the desired heating area and reduces this component in the area directly under the face of the conductor 30 in the passive inductor 28. This leads to an increased gradient in the power density in cross-section compared to the use of a magnetic back-pad 24 alone.

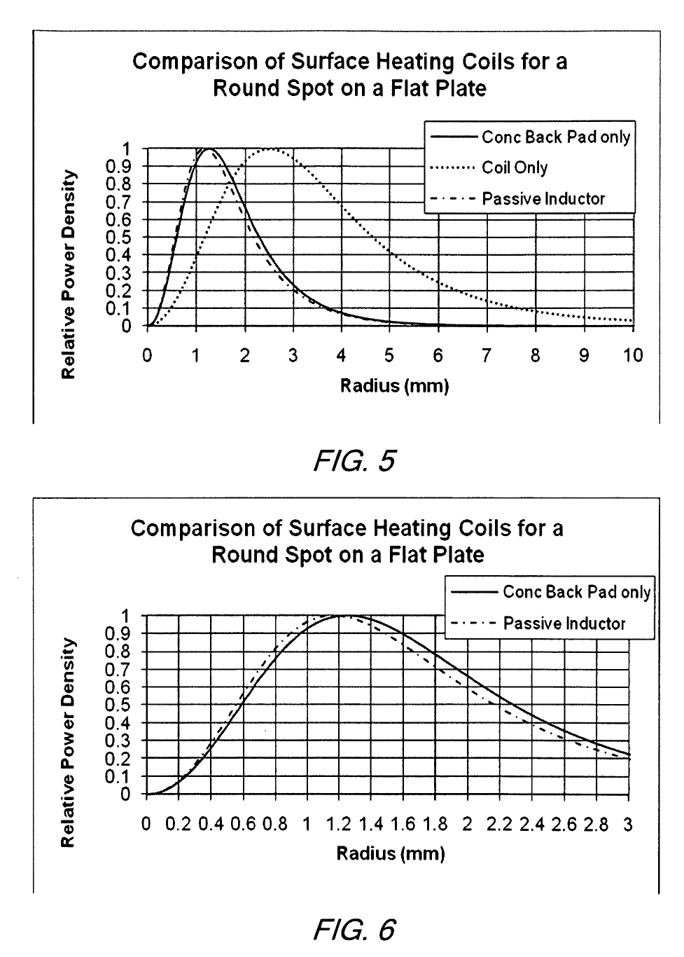

FIG. 5 is a comparison of the power density along the length of the sheet 18 for the inductor 10 only, inductor 10 with magnetic back-pad 24, and inductor 10 with passive inductor 28. It is clear that there is a drastic improvement with both the magnetic back-pad 24 and passive inductor 28 being used with the induction coil 10 compared to the induction coil 10 alone. To better appreciate the advantages of the passive inductor 28 working in combination with the induction coil 10 compared to the magnetic back-pad 24 working in combination with coil 10, FIG. 6 shows a comparison of only these two cases up to a radius of three millimeters. The peak for the passive inductor 28 is at a significantly smaller radius compared to the magnetic back-pad 24 alone. In addition, the power density at radii past the peak values is significantly lower for the passive inductor 28 compared to the magnetic back-pad 24 alone. This will lead to a smaller heating spot size from the passive inductor 28.

Further heat pattern control is also possible in the length or depth of the coil 10 and part by adjusting the passive inductor 28 component dimensions. An example would be to heat several zones on a flat, linear surface simultaneously, such as the thin, flat body 18, without heating the areas in between. This could be accomplished by using several conductors 30, and removing the magnetic core 32 in the areas where heating was undesirable and bringing the conductors 30 closer together. Without the core 32, and with a very small space for magnetic flux to flow through between the conductors 30, the magnetic resistance of the path for the magnetic field would be increased and the heating would be subsequently decreased.

The passive induction system of the present invention is useful for providing localized heating in applications such as precise control soldering. The passive induction system of the present invention may be used for heating environments, connecting electrical components to circuit boards, localized heating in packaging applications, thin layer silicon soldering, or the like. As mentioned above, the thin, flat sheet 18 is substantially transparent to a magnetic field. The sheet 18 in one embodiment may be 150 μm or less. The thickness of the sheet 18 with which the subject invention is effective is selected based on the electrical reference depth, or skin depth. The electrical reference depth, “δ,” (Greek letter “Delta”) is a reference value which depends on material properties and frequency, but does not account for body size and shape. For non-uniform materials, δ is calculated usually for properties on the body surface. Reference depth, δ, is directly proportional to root square of material resistivity, “ρ” (Greek letter “Roh”), and inversely proportional to root square of relative magnetic permeability “μ” (Greek letter “Mu”), and current frequency.

The equation for the reference depth is: δ=k√(ρ/fμ)

In this equation, “f” is the frequency, and “k” is a constant. The units for these values are shown below:

| System | ρ | f | δ | k |
|---|---|---|---|---|
| Metric | mkOhm-cm | kHz | Millimeters | 1.6 |
| English | mkOhm-inch | kHz | Inches | 0.1 |

The thickness of the sheet 18 is generally one reference depth or less, and is typically substantially one-third of a reference depth or less, and preferably is one-fifth of a reference depth or less. A passive induction system according to the present invention may be used for performing soldering operations on a sheet 18 having a larger thickness, depending upon the frequency of the current flowing through the induction coil 10.

The description of the invention is merely exemplary in nature and, thus, variations that do not depart from the gist of the invention are intended to be within the scope of the invention. For example, variations in cooling methods and methods of fixturing of the passive inductor of the present invention are not to be regarded as a departure from the spirit and scope of the invention.

What is claimed is:

1. A magnetic flux controlling device having a passive inductor for generating induction heating of an object, comprising at least one electrical conductor operable for generating a desired heating area on said object, wherein said at least one electrical conductor does not form a closed electrical loop.

2. The magnetic flux controlling device of claim 1, further comprising an induction heating coil, wherein said passive inductor is located on the opposite side of said object as said induction heating coil.

3. The magnetic flux controlling device of claim 2, further comprising a magnetic flux concentrator, wherein said at least one electrical conductor is operable with said magnetic flux concentrator to generate a desired heating area on said object.

4. The magnetic flux controlling device of claim 3, said induction heating coil further comprising an axis, wherein said passive inductor is adjusted along said axis of said induction heating coil to precisely control the power density by variation of the dimensions of said magnetic flux concentrator.

5. The magnetic flux controlling device of claim 2, said induction heating coil further comprising an axis, wherein said passive inductor is adjusted along said axis of said induction heating coil to precisely control the power density by variation of the electrical conductor dimensions.

6. The magnetic flux controlling device having a passive inductor for generating induction heating of an object of claim 1, said object further comprising at least one thin, flat body.

7. A passive induction system for providing heating of an object, comprising:
at least one induction coil located in proximity to an object, said at least one induction coil operable for generating a magnetic field; and
at least one passive inductor located in proximity to said induction coil, wherein said at least one passive inductor is operable to control the magnetic flux between said at least one induction coil and said at least one passive inductor, thereby providing control of heat generated on said object.

8. The passive induction system of claim 7, said at least one induction coil further comprising:
a magnetic flux concentrator; and
at least one coil winding operable with said magnetic flux concentrator for directing magnetic flux of said magnetic field toward said object.

9. The passive induction system of claim 7, said at least one passive inductor further comprising:
a core; and
a conductor operable with said core such that said magnetic field generated by said at least one induction coil is drawn toward said core such that a portion of said magnetic field is directed away from said conductor, and a portion of said magnetic field flows through said core.

10. The passive induction system of claim 9, further comprising:
at least one flux surface formed as part of said core; and
a front side and a back side formed as part of said conductor, wherein said portion of said magnetic field that flows through said core will flow through said core via said at least one flux surface and along said back side of said conductor.

11. The passive induction system of claim 7, said at least one passive inductor being located on the opposite side of said object in relation to said at least one induction coil.

12. The passive induction system of claim 7, said object further comprising a thin, flat sheet, said induction coil being located on one side of said sheet, and said at least one passive inductor being located on another side of said thin, flat sheet.

13. The passive induction system of claim 12, said thin, flat sheet having a thickness of substantially one reference depth or less.

14. The passive induction system of claim 12, said thin, flat sheet having a thickness of substantially a fraction of one reference depth or less.

15. The passive induction system of claim 12, said thin, flat sheet having a thickness of substantially one-third of a reference depth or less.

16. The passive induction system of claim 12, said thin, flat sheet having a thickness of substantially one-fifth of a reference depth or less.

17. A passive induction system operable for heating a thin, flat body, comprising:
an induction coil having at least one coil winding and a magnetic flux concentrator, said induction coil being operable for generating a magnetic field;
a thin, flat body located in proximity to said induction coil said induction coil being located in proximity to said thin, flat body; and
a passive inductor located on the opposite side of said thin, flat body compared to said induction coil, said passive inductor being operable with said induction coil for controlling the amount of heat generated on said thin, flat body.

18. The passive induction system of claim 14, said passive inductor further comprising:
a core having at least one flux surface; and
a conductor having a front side and a back side, said conductor being operable with said core such that said magnetic field generated by said at least one induction coil is drawn toward said core such that a portion of said magnetic field is directed away from said front side of said conductor, and a portion of said magnetic field flows through said core via said at least one flux surface and along said back side of said conductor.

19. The passive induction system of claim 14, said at least one induction coil further comprising:
a magnetic flux concentrator; and
a plurality of coil windings operable with said magnetic flux concentrator for directing magnetic flux of said magnetic field toward said thin, flat body.

20. The passive induction system of claim 14, said thin, flat body having a thickness of substantially 150 μm or less.

21. A method for providing passive induction heating of an object, comprising the steps of:
providing at least one induction coil operable for generating a magnetic field;
providing at least one passive inductor;
locating said at least one passive inductor on the opposite side of said object in relation to said at least on induction coil; and
using said at least one passive inductor for controlling the magnetic flux between said at least one induction coil and said at least one passive inductor such that heat generated on said object is controlled.

22. The method of claim 21, further comprising the steps of:
providing said at least one induction coil to further include at least one coil winding;
providing said at least one induction coil to further include a magnetic flux concentrator; and
directing said magnetic field toward said object using said at least one induction coil.

23. The method of claim 21, further comprising the steps of:
providing said at least one passive inductor to further include a core;
providing said at least one passive inductor to further include a conductor; and
drawing said magnetic field toward said core from said at least one induction coil such that at least a portion of said magnetic field is directed away from said conductor, and at least a portion of said magnetic field flows through said core.

24. The method of claim 23, further comprising the steps of:
providing at least one flux surface formed as part of said core;
providing a front side formed as part of said conductor;
providing a back side formed as part of said conductor; and
directing a portion of said magnetic field which flows through said core to flow through said at least one flux surface and along said back side of said conductor.

25. The method of claim 21, further comprising the steps of providing said object to be comprised of a thin, flat sheet.
